(19) United States
(12) Patent Application Publication
(10) Pub. No.: US 2010/0117389 A1
(43) Pub. Date: May 13, 2010

(54) LIFTING APPARATUS FOR LIFTING HOLLOW FRAMES SUCH AS MANHOLE OR CATCHMENT BASIN FRAMES

(76) Inventor: Daniel James Poole, Nova Scotia (CA)

Correspondence Address: KATTEN MUCHIN ROSENMAN LLP, 575 MADISON AVENUE, NEW YORK, NY, 10022-2585, US

(21) Appl. No.: 12/575,658

(22) Filed: Oct. 8, 2009

(30) Foreign Application Priority Data
Nov. 13, 2008 (CA) 2643797

(51) Int. Cl. B66C 1/54; B66C 1/28; B66C 1/42

(52) U.S. Cl. 294/81.21; 294/81.61

(57) ABSTRACT

Apparatus for lifting a hollow frame when the apparatus is attached to a hoist, comprising a pair of lifting members each in the form of a bell crank having an upright arm and a lateral arm, extending outwardly from a lower end of the upright arm, outer ends of the lateral arms having flanges for engaging the interior of the frame to be lifted. The lifting members are connected back-to-back by brackets and a central pivot. Suspension chains connect upper ends of the upright arms to a hoist chain such that the suspension chains slope outwardly from the hoist chain to the arms, and so that when the hoist chain applies tension to the suspension chains the upright arms are pulled towards each other while causing the lateral arms to extend and engage with the inside of the hollow frame.

### BACKGROUND OF THE INVENTION

1. Field of the Invention

The present invention relates to lifting apparatus for lifting hollow frames, such as the frames used for manholes frames or catchment basin frames. However, the invention is applicable to many kinds of hollow frames which can be engaged by lifting members contacting an interior of the frame.

Manhole cover frames, and similar frames used for catchment basins, are usually large metal castings. While some of these can be lifted manually by two or more men, they are heavy and strains and injuries can result from manual lifting.

2. Prior Art

The prior art contains some suggestions for allowing these frames to be lifted by hoist means such as back-hoes or small cranes. One kind of device is shown in U.S. Pat. Nos. 5,306,062 and 5,476,300 to Dodge, issued respectively Apr. 26, 1994 and Dec. 19, 1995, in which a central, upwardly extending lifting bar connected to the hoist means has its lower end fixed to a horizontal plate. The plate carries laterally extending means for engaging the interior of the frame, these engagement means being in the form of four mutually perpendicular lifting lugs which can be slid outwardly to engage an undersurface of the frame when the device has been positioned within the frame. Use of this device would require some time-consuming manipulation of the lifting lugs.

Another patent relating to lifting manhole cover frames is U.S. Pat. No. 6,276,732, issued Aug. 21, 2001 to Haus. Here the device grips the outside of the frame, by frictional gripping pads attached to the lower ends of two scissor-like bars; accordingly this would not appear to provide secure holding of a heavy frame.

### SUMMARY OF THE INVENTION

The present invention provides apparatus which holds a hollow frame securely by using engaging means which engage inner and underside surfaces of the frame, as in the Dodge patents, but the expansion of the engagement means in this case is automatic and does not require time-consuming manipulation. Rather than using a scissor-like mechanism as in Haus, the apparatus uses, in its preferred embodiment, lifting members which are connected by pivots so that inwards movement of upper ends of the lifting members causes outwards movement of members which engage the inside of a frame.

According to the broad aspect of the present invention, lifting apparatus for lifting a hollow frame when the apparatus is attached to hoist me ns comprises, a pair of lifting members, each having a normally upright arm and a normally lateral arm, said lateral arms of the lifting members extending outwardly from each other, outer ends of said lateral arms having engaging means for engaging the interior of a frame to be lifted, pivot means connecting said lifting members, said pivot means being connected to said upright arms at positions which are above the lateral arms and such that rotation of each of said lifting members in a first sense about said pivot means causes outwards movement of the lateral arm of that lifting member, flexible suspension means adapted to connect outer end portions of the upright arms of the lifting members to hoisting means positioned above said pivot means, said suspension means being arranged such that tension in said suspension means occurs along a line of force which causes rotation of said lifting members in said first sense, the arrangement being such that when said hoist means applies tension to lift the suspension means, tension in said suspension means rotates the lifting members in said first sense thus causing the lateral arms to extend into contact with the inside of a said hollow frame surrounding the apparatus.

Preferably, the suspension means includes flexible members which connect a central hoist means to upper ends of said upright arms, said flexible members diverging outwardly and downwardly from said central hoist means so as to pull the upper ends of the lifting members together when tension is applied thereto, thus rotating the lifting members in said first sense. The flexible members may be chains.

The lifting members may be in the form of oppositely facing, back-to-back bell cranks, with the pivot means connecting brackets which extend from the inner sides of the upright arms.

The engaging means on said lateral arms may each have an upright flange for contacting the inside of a frame, and a lower flange for contacting the underside of the frame.

Preferably, the lateral arms are in the form of hollow sockets, and each said engaging means has a shaft fitting into a said socket. The apparatus may include two interchangeable engaging means for each lifting member, each with a shaft for selective positioning in each lateral arm, and each engaging means carries said upright and lower flanges. The engaging means may be selectively suitable for rectangular or circular or square frames.

### BRIEF DESCRIPTION OF THE DRAWINGS

A preferred embodiment of the invention will now be described by way of example with reference to the accompanying drawings, in which;

FIG. 1 is a perspective view of the apparatus as adapted for lifting a rectangular frame, the apparatus shown resting on the ground;

FIG. 2 is a view similar to FIG. 1, but with the apparatus engaged within a rectangular frame, and with a lifting force being provided by hoist means not shown;

FIG. 3 is a side view of a lower portion of a lifting member with engagement means suitable for the rectangular frame;

FIG. 4 is a perspective view of a lower portion of a lifting member with engagement means suitable for a circular frame, and

FIG. 5 is a perspective view of the apparatus in partly disassembled form, showing the different engagement means for rectangular or circular or square frames.

### DESCRIPTION OF THE PREFERRED EMBODIMENT

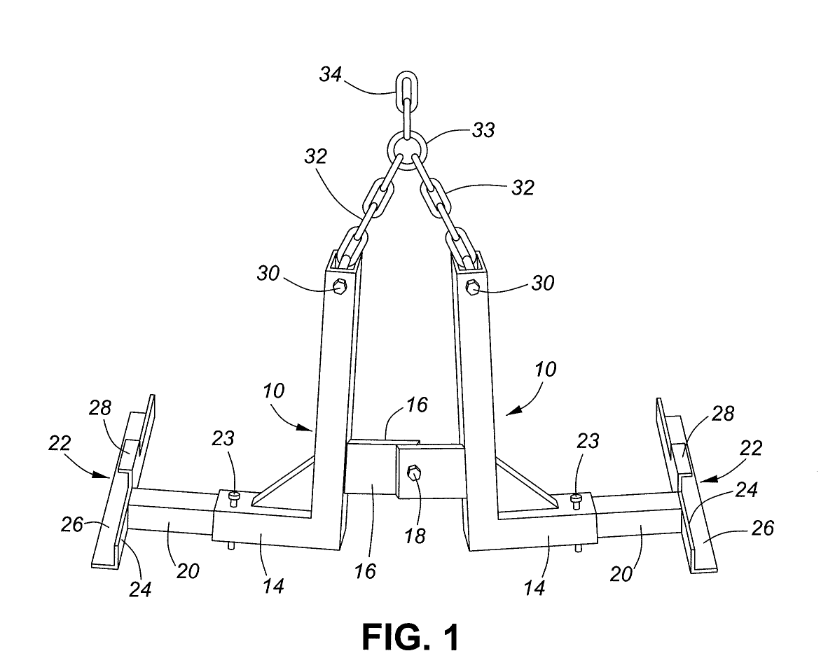

As shown in FIGS. 1, 2, 3 and 5, the apparatus comprises two lifting members 10, each with a normally upright arm 12, shown as vertical in FIG. 1, and each with a lateral arm 14 projecting outwards at right angles to the arm 12; gussets 15 and welded joints connect the two arms of each member. The two lifting members have brackets 16 extending inwardly from the arms 12, at about ¼ or ⅓ the height of the upright arms above the level of the lateral arms, and pivot means such as a bolt 18 connects inner ends of the brackets. Thus, the two members take the form of two back-to-back bell cranks, joined by brackets 16 and pivot 18.

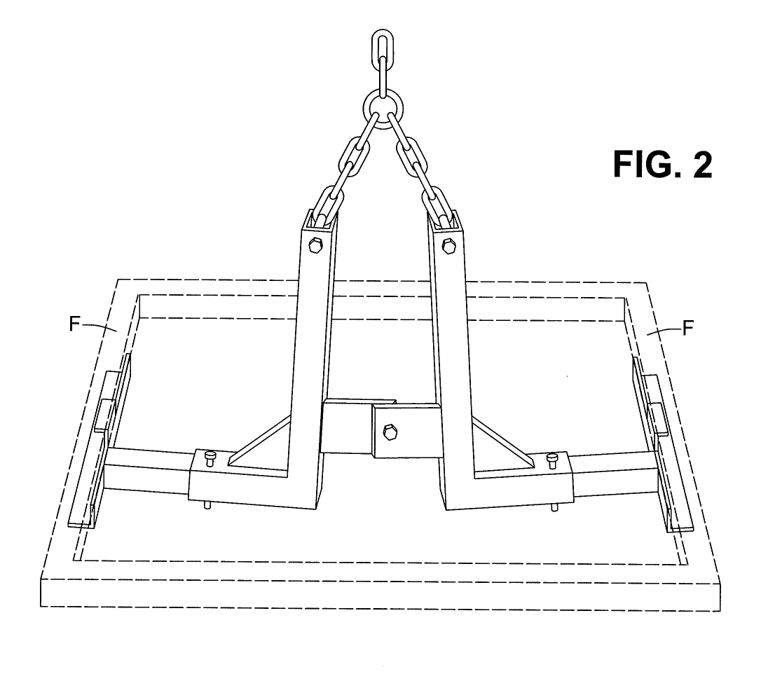

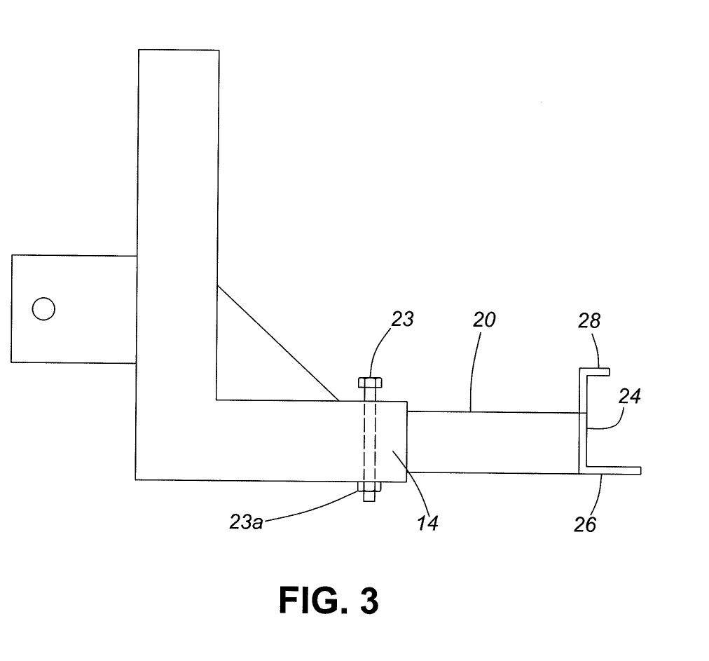

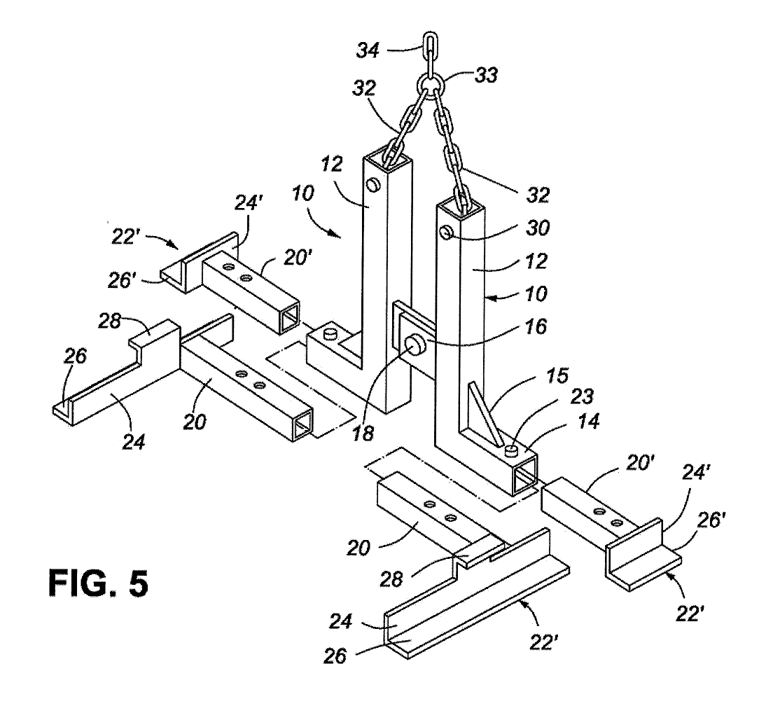

The lateral arms 14 are of square sectioned steel tubing with open outer ends. These provide sockets for the shafts 20 of frame engaging means 22 shown in FIGS. 1, 2, 3 and 5; the shafts 20 can be locked in position by bolts 23 held by cotter pins or nuts 23a (seen in FIG. 3), the shafts 20 preferably having multiple holes therein (as illustrated in FIG. 5) which can be used to adjust the engaging means to the width of a frame to be lifted. The engaging means 22 are designed to engage the opposite sides of a rectangular or square frame F as shown in FIG. 2. Each of these engaging means, in the form shown in FIGS. 1, 2, 3, and 5, has an upright flange 24 for engaging the inside of the frame F shown in FIG. 2, a horizontal lower flange 26 for engaging the underside of the frame, and an upper horizontal flange 28 for engaging the upper surface of the frame.

As seen in FIGS. 1 and 2, the arms 12 are also in the form of square tubes, and at their upper ends these arms are provided with cross bolts 30 which each hold the ends of two short chains 32 which provide suspension means by which the lifting members can be lifted by shackle 33 connected to a main chain 34, which can be lifted by various powered hoist means such as a small crane or a backhoe. Since the short chains 32 slope inwardly from the bolts 30 to shackle 33 they can exert forces along lines of force which are outside the pivot means 18, and when these chains 32 are tensioned by lifting forces on chain 34 they pull the upper ends of arms 12 inwardly, and so rotate the lifting members in a sense which causes those parts of the lifting members below pivot 18 to move outwardly. This rotation brings the flanges 24, 26 and 28 of engaging means 22 into firm contact with the sides of frame F.

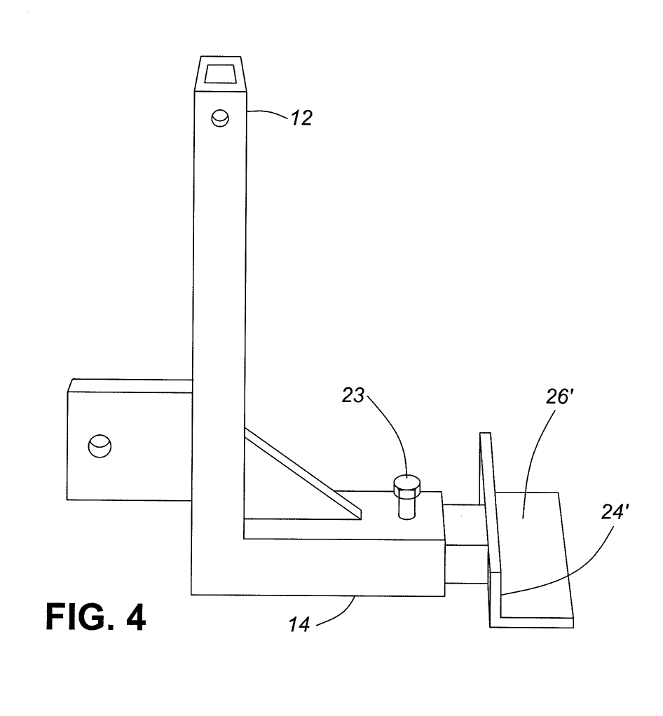

FIGS. 4 and 5 show another form of engaging means 22′ having square shaft 20′ which can be selectively fitted into the socket in arm 14, and which has a short upright flange 24′ and a short horizontal flange 26′, but has no upper flange. These engaging means 22′ are suitable for engaging opposite sides of a circular frame. They are also held in place by a bolt or set screw 23. The shafts 20′ preferably have multiple holes therein (as illustrated in FIG. 5) which can be used to adjust the engaging means to the width or diameter of a frame to be lifted.

It will be seen that operation of this apparatus is quite simple, and does not require the manipulation needed in use of the Dodge patents. With the hoist chains slack, the apparatus can rest on the ground, as in FIG. 1, within a frame to be lifted, with the upright arms 12 substantially vertical. When lifting tension is applied to the chains, the lifting members 10 are rotated to cause the lateral arms 14 to extend outwards bringing the engaging means 22 or 22′ into engagement with the frame, as shown in FIG. 2. Further tension on the chains lifts the frame.

The present invention has been described herein with regard to preferred embodiments. However, it will be obvious to persons skilled in the art that a number of variations and modifications can be made without departing from the scope of the invention as described herein.

1. Lifting apparatus for lifting a hollow frame when the apparatus is attached to hoisting means, the apparatus comprising:
a pair of lifting members, each having a normally upright arm and a normally lateral arm, said lateral arms of the lifting members extending outwardly from each other, outer ends of said lateral arms having engaging means for engaging the interior of a frame to be lifted,
pivot means connecting said lifting members, said pivot means being connected to said upright arms at positions which are above the lateral arms and such that rotation of each of said lifting members in a first sense about said pivot means causes outwards movement of the lateral arm of that lifting member,
flexible suspension means adapted to connect outer end portions of the upright arms of the lifting members to hoisting means positioned above said pivot means, said suspension means being arranged such that tension in said suspension means occurs along a line of force which causes rotation of said lifting members in said first sense, the arrangement being such that when said hoisting means applies tension to lift the suspension means, tension in said suspension means rotates the lifting members in said first sense thus causing the lateral arms to extend into contact with the inside of a said hollow frame surrounding the said apparatus.

2. Lifting apparatus according to claim 1, wherein said suspension means includes flexible members which connect a central hoist means to upper ends of said upright arms, said flexible members diverging outwardly and downwardly from said central hoist means so as to pull the upper ends of said upright arms together when tension is applied thereto, thus rotating the lifting members in said first sense.

3. Lifting apparatus according to claim 1, wherein said engaging means on said lateral arms each have an upright flange for contacting the inside of a frame, and a lower flange for contacting the underside of the frame.

4. Lifting apparatus according to claim 3, wherein said lateral arms are in the form of hollow sockets, and wherein each said engaging means has shaft fitting into a said socket.

5. Lifting apparatus according to claim 4, wherein two interchangeable engaging means each with a shaft are provided for selective positioning in each lateral arm, and each engaging means carries said upright and lower flanges.

6. Lifting apparatus for lifting a hollow frame when the apparatus is attached to hoisting means, the apparatus comprising:
a pair of lifting members, each having a normally upright arm and a normally lateral arm extending outwardly from a lower end of the upright arm, outer ends of said lateral arms having engaging means for engaging the interior of a frame to be lifted, said engagement means including an upright flange for engaging an inner surface of a said frame and a lower flange for fitting under an underside of the frame, each upright arm of the lifting members having a bracket extending inwardly towards the other member, each said bracket being located above the lateral arm and below the upper end of the upright arm,
pivot means connecting inner ends of said brackets such that said lateral arms extend outwardly from each other, the lifting members thus constituting opposed bell cranks, flexible suspension means adapted to connect outer, upper end portions of the upright arms of the members to hoisting means positioned above said pivot means such that the suspension means slope outwardly from the hoisting means to the arms,
the arrangement being such that when said hoisting means applies tension to lift the suspension means such tension pulls upper ends of the upright arms towards each other while causing the lateral arms to extend into contact with the inside of a said hollow frame surrounding the apparatus.

7. Lifting apparatus according to claim 6, wherein said lateral arms are in the form of hollow sockets, and wherein each engaging means has shaft fitting into a said socket.

8. Lifting apparatus according to claim 7, wherein two interchangeable engaging means each with a shaft are provided for selective positioning in each lateral arm, and each engaging means carries said upright and lower flanges.
